(19) United States
(12) Patent Application Publication
(10) Pub. No.: US 2021/0178922 A1
(43) Pub. Date: Jun. 17, 2021

(54) Systems and Methods for Side-Body Charging of Electric Vehicles

(71) Applicant: ABB Schweiz AG, Baden (CH)

(72) Inventors: Gregory A. Cole, West Hartford, CT (US); Alexander P. Riley, Manchester, CT (US); William J. Eakins, Coventry, CT (US)

(73) Assignee: ABB Schweiz AG, Baden (CH)

(21) Appl. No.: 16/710,451

(22) Filed: Dec. 11, 2019

(51) Int. Cl. B60L 53/37; H02J 7/00; B60L 53/16; B60L 53/31

(52) U.S. Cl. CPC B60L 53/37; B60L 53/31; B60L 53/16; H02J 7/0045

(57) ABSTRACT

Devices, systems, and methods for electric vehicle (EV) charging are disclosed. Devices include a base and at least one vertical rail coupled to the base and extending upward therefrom, and at least one slide engaged with the rail(s). Single rail devices include at least two slides engaged with the rail. Devices having at least two rails include at least one slide engaged with each of the rails. A connector unit having a first end and a second end is pivotably coupled to a plurality of elongate support arms at portions of the second end. An opposite end of each support arm is pivotably coupled to individual slide(s). The disclosed devices, systems and methods enable precise positioning of charger electrical connectors for mating engagement with vehicle electrical connectors for EV charging. Automation features are integratable for hands-free operation in a variety of residential and commercial EV charging environments.

### TECHNICAL FIELD

The present disclosure relates to charging systems and methods for electric vehicles (EVs) and, more particularly, to systems and methods for effecting an electrical connection between a vehicle charger and the electric vehicle.

### BACKGROUND

Use of EVs is becoming increasingly popular due to the environmental benefits of removing pollution caused by fossil fuel burning vehicle engines from the environment, especially in densely populated urban environments. As with most mobile electrical devices, EVs carry electrical power storage devices or batteries, which provide power to the vehicle propulsion and other systems. As can be appreciated, the vehicle batteries require periodic recharging to provide consistent vehicle operation.

At present, EV recharging is a time consuming process that is typically carried out over long periods, for example, overnight or during prolonged periods when the electric vehicle is parked. Power dispensers include flexible conduits or wire bundles that include a connector at their end, which plugs into a vehicle receptacle and then begins the transfer of power from the dispenser the vehicle's battery.

Traditional vehicle power dispensers operate at around 200-240 Volt AC, and transfer about 30 Amp of electrical power into a vehicle. As a consequence, providing a full charge to a vehicle can take up to 10 hours or more. With the increase in popularity of EVs, faster charging solutions which are easier and safer to operate, and which can be retrofitted into existing fully electric or hybrid vehicles and facilities are required.

### SUMMARY OF THE DISCLOSURE

The below-described systems and methods for side-body charging of EVs provide space- and cost-efficient mechanisms for efficient, reliable and safe charging operations. As compared to known systems and methods, the embodiments disclosed herein provide a number of technical benefits and user advantages in a wide variety of operational environments ranging from home use to commercial contexts. By employing simple yet robust components and other design elements, the disclosed systems and methods for side-body charging or EVs are easy to maintain and they may be cost-effectively retrofitted into existing EVs and facilities.

Devices, systems, and methods for EV charging are disclosed. Charging devices include a base and at least one vertical rail coupled to the base and extending upward therefrom, and at least one slide engaged with the rail(s). Single rail charging devices include at least two slides engaged with the rail. Charging devices having at least two rails include at least one slide engaged with each of the rails. A connector unit having a first end and a second end is pivotably coupled to a plurality of elongate support arms at portions of the second end. An opposite end of each support arm is pivotably coupled to individual slide(s). The disclosed devices, systems and methods enable accurate and precise positioning of charger electrical connectors for mating engagement with vehicle electrical connectors for EV charging. Automation and/or robotic features are integratable into the disclosed charging devices, systems and methods for hands-free operation in a variety of residential and commercial EV charging environments.

In one aspect, the disclosure describes a device for charging of an EV including a vehicle electrical connector. The device includes a base positioned on or in a ground surface and a vertical rail coupled to the base and extending vertically upward from the base. The device includes a pair of slides engaged with the rail. The device includes a connector unit having a first end and a second end. The device includes a pair of elongate support arms. Each support arm of the pair of support arms is pivotably coupled to and between: one slide of the pair of slides, and one of two portions of the second end of the connector unit.

In another aspect, the disclosure describes a device for charging of an EV including a vehicle electrical connector. The device includes a base positioned on or in a ground surface and at least two vertical rails coupled to spaced portions of the base and extending vertically upward from the base. The device includes at least one slide engaged with each rail of the at least two rails. The device includes a connector unit having a first end and a second end. The device includes a plurality of elongate support arms. The support arms include at least one support arm pivotably coupled to and between the at least one slide engaged with a first rail of the at least two rails and a first portion of the second end of the connector unit. The support arms include at least one additional support arm pivotably coupled to and between the at least one slide engaged with a second rail of the at least two rails and a second portion of the second end of the connector unit.

In yet another aspect, the disclosure describes a method for charging of an EV. The method includes positioning a charger electrical connector of a charging device with reference to a mating vehicle electrical connector positioned proximal a side-body panel of the EV. The positioning step includes actuating the charger electrical connector from an initial position to a final position with the charger electrical connector matingly engaged with the vehicle electrical connector. The actuating step includes moving at least two slides coupled to the charger electrical connector by way of at least two support arms vertically along at least one rail of the charging device to selectively position the charger electrical connector at least one of: vertically, and radially, with respect to an axis of the at least one rail. The method includes inserting the charger electrical connector of the charging device into the mating vehicle electrical connector. The method includes initiating an EV charging process by selectively enabling a flow of electric current from an electric power supply through the matingly engaged charger and vehicle electrical connectors.

Further and alternative aspects and features of the disclosed principles will be appreciated from the following detailed description and the accompanying drawings. As will be appreciated, the principles related to devices, systems, and methods for side-body charging of EVs disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a perspective view of an electric vehicle (EV) charging environment according to an embodiment of the disclosure.

FIG. 2 is a flowchart of a method for side-body charging of EVs according to an embodiment of the disclosure.

FIGS. 3A-3F are schematic diagrams of aspects of automated charging devices (ACDs) for side-body charging of EVs according to embodiments of the disclosure.

FIGS. 4A-4G are schematic diagrams of aspects of the ACD of FIGS. 3C-3E in actuated positions according to an embodiment of the disclosure.

FIGS. 5A-5C are schematic diagrams of aspects of the ACD of FIGS. 3C-4G in a tilted position according to an embodiment of the disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

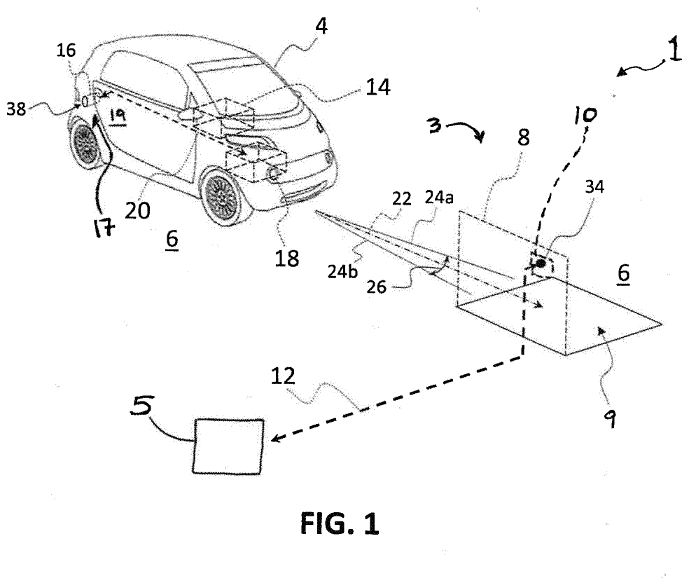

FIG. 1 is a schematic diagram of a system 1 for charging an EV 4 in an EV charging environment 3 according to an embodiment of the disclosure. In the example shown in FIG. 1, an EV 4 is positioned on a ground surface 6. EV 4 is a car, as shown in FIG. 1. Alternatively, EV 4 may be a truck, a motorcycle, a moped, a bus, a scooter, a farm implement or any other on- or off-highway vehicle. In the example shown, ground surface 6 is a floor of a garage or other vehicle storage facility of a home or business. Alternatively, ground surface 6 may be a surface of a parking lot. System 1 includes an automated charging device (ACD) 8 that is positioned, or is at least positionable, in, or proximal, charging environment 3. In the illustrated example, ACD 8 is positioned on or, at least in part, beneath ground surface 6 and proximal a charging zone 9. In one embodiment, charging zone 9 is at least a portion of a parking space of a parking facility like a parking lot or a garage. In another embodiment, charging zone 9 is at least a portion of a residential garage structure or driveway.

At least a portion of ACD 8 rises above ground surface 6 by a height that is sufficient to facilitate operation of the ACD 8 as disclosed herein. In other embodiments (not shown) all, or a part, of ACD 8 may be wall mounted or ceiling mounted. ACD 8 includes a connector unit 10 with a charger electrical connector 34. At least a portion of connector unit 10 faces and is exposed or exposable to a space above charging zone 9. Connector unit 10 of ACD 8 is operatively coupled to or associated with an electric power supply 5 (e.g., a utility grid), either directly or through a transforming, conditioning, and/or conversion device such as a transformer. Charger electrical connector 34 is coupled to, or is at least coupleable to, the power supply 5. A first electric power flow 12 can thus be selectively enabled between the power supply 5 and the ACD 8, including to connector unit 10. In some embodiments, the first electric power flow 12 is selectively enabled between the ACD 8 and the power supply 5, as where an EV 4 is supplying (e.g., selling back) electric power to the grid.

As used herein, the phrase “operably (or operatively) coupled (or connected),” refers to two or more functionally-related components being coupled to one another for purposes of translation and/or transfer of a mechanical force, a flow of electric current, and/or a flow of data signals. In the case of data communication, this coupling of the two or more components may be a wired connection and/or a wireless connection.

EV 4 includes a drivetrain 14 providing motive power to the EV 4 for driving. System 1 includes a vehicle unit 16 that is positioned, or is at least positionable, in, on, or proximal, a side-body panel 17 of the EV 4. Vehicle unit 16 includes a vehicle electrical connector 38 that is coupled to, or is at least coupleable to, at least one power storage device 18 (e.g., a rechargeable battery) positioned in or on the EV 4. Battery 18 is operatively coupled to drivetrain 14 for providing electric power thereto to enable providing motive power for EV 4 selectively during operation. Structures and systems of the EV 4 that accomplish the provision of power to the drivetrain 14 selectively by an operator (not shown) of the EV 4 are omitted for simplicity.

At least a portion of vehicle unit 16 faces the EV 4 side-panel 17 and is exposed or exposable to a space outside of the EV 4 (e.g., an EV exterior 19). Similarly, vehicle electrical connector 38 is positioned, or is at least positionable, to face the EV exterior 19. It is noted that, while the EV 4 is shown in one orientation as it approaches the ACD 8 and charging zone 9, any orientation of approach is also contemplated. Vehicle unit 16 is operatively coupled to battery 18 to provide an interface for providing electrical power to charge the battery 18. A second electric power flow 20 is thus enabled between vehicle unit 16 and battery 18. The charger electrical connector 34 is positioned, or is at least positionable, to matingly engage the vehicle electrical connector 38 in the charging environment 3, to facilitate a flow of current (e.g., 12, 20) between the power supply 5 and the power storage device 18 through the matingly engaged vehicle 38 and charger 34 electrical connectors for purposes of charging the power storage device 18.

In the EV charging environment 3 shown in FIG. 1, EV 4 is being driven and approaches the charging zone 9 having the ACD 8 positioned proximal one side of the charging zone 9. A driver of EV 4 (e.g., a human driver and/or an autonomous vehicle driving system, not shown in FIG. 1) steers or otherwise controls the EV 4 to approach charging zone 9 along a centerline path 22. As shown in FIG. 1, centerline path 22 extends from EV 4 to at least approximately a center point of charging zone 9 on ground surface 6. Based on the particular dimensions and other specifications of EV 4, charging zone 9, ACD 8 including connector unit 10, and/or vehicle unit 16, an approach path of EV 4 to ACD 8 including connector unit 10 may deviate from the target centerline path 22 by an allowable deviation 24. The allowable deviation may be in any direction, including but not limited to a horizontal or vertical direction. Allowable deviation 24 includes a driver side deviation 24a and a passenger side deviation 24b. An allowable deviation angle 26 is defined between lines defining driver side deviation 24a and passenger side deviation 24b. In three dimensions, the deviation angle 26 may form a conical area that accounts for height of vehicle unit 16 and/or ground clearance of the vehicle, as well pitch, yaw and roll of the vehicle's trajectory during the approach to the ACD 8, and also during the connection and charging operations according, for example, to the disclosed embodiments.

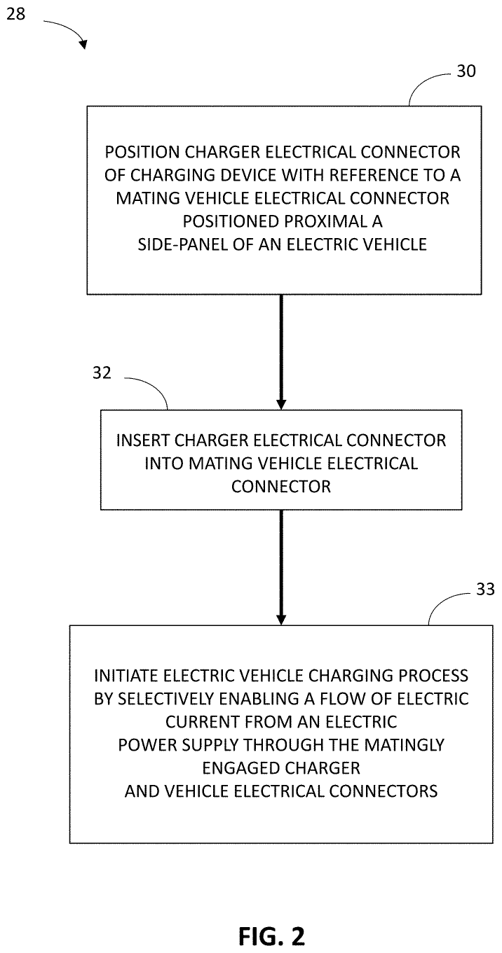

FIG. 2 is a flowchart of a method 28 for side-body charging of EV 4 according to an embodiment of the disclosure. In an example, method 28 is implemented and performed, at least in part, by ACD 8, which actuates connector unit 10 from a stationary (e.g., initial) position through a series of intermediate positions toward the vehicle unit 16 to facilitate a mating engagement (e.g., electrical connection) between charger electrical connector 34 and vehicle electrical connector 38 for charging when the EV 4 is stationary in the charging zone 9 proximal ACD 8.

Referring to FIG. 2, method 28 includes positioning at 30 the charger electrical connector 34 of the charging device 8 with reference to the mating vehicle electrical connector 38 positioned proximal the side-body panel 17 of the EV 4. Such positioning and/or placement may be carried out automatically, robotically and/or manually (by hand). Connector unit 10 includes a handle 29 to facilitate the manual positioning of connector unit 10 for performing the positioning step 30 by hand. The positioning step 30 includes actuating the charger electrical connector 34 from an initial position to a final position. In the initial position, and in intermediate position(s) between the initial and final positions, the charger electrical connector 34 is not matingly engaged with the vehicle electrical connector 38. In the final position, the charger electrical connector 34 is matingly engaged with the vehicle electrical connector 38. The actuating step includes moving at least two slides 56 coupled to the charger electrical connector 34 by way of at least two support arms 52 vertically along at least one rail 44 of the charging device 8 to selectively position the charger electrical connector 34 at least one of: vertically, and radially, with respect to an axis 15 of the at least one rail 44. The method 28 includes inserting at 32 the charger electrical connector 34 of the charging device 8 into the mating vehicle electrical connector 38. The charger electrical connector 34 is inserted at 32 into vehicle electrical connector 38 either simultaneously with, or after, connector 34 being positioned with reference to connector 38. The handle 29 facilitates performance by an ACD 8 user of the inserting step 32 by hand. After the inserting step 32 to attain the final position of connector 34, method 28 includes initiating at 33 an EV 4 charging process by selectively enabling a flow 12 of electric current from an electric power supply 5 through the matingly engaged charger 34 and vehicle 38 electrical connectors to charge battery 18. The initiating step 33 may be performed automatically or manually (e.g., via a hand-operated switch, not shown).

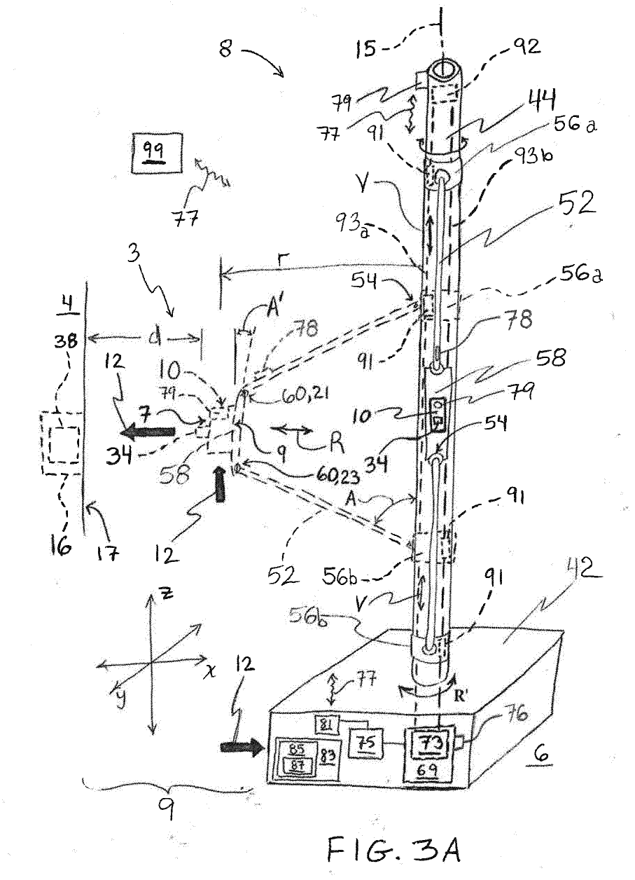

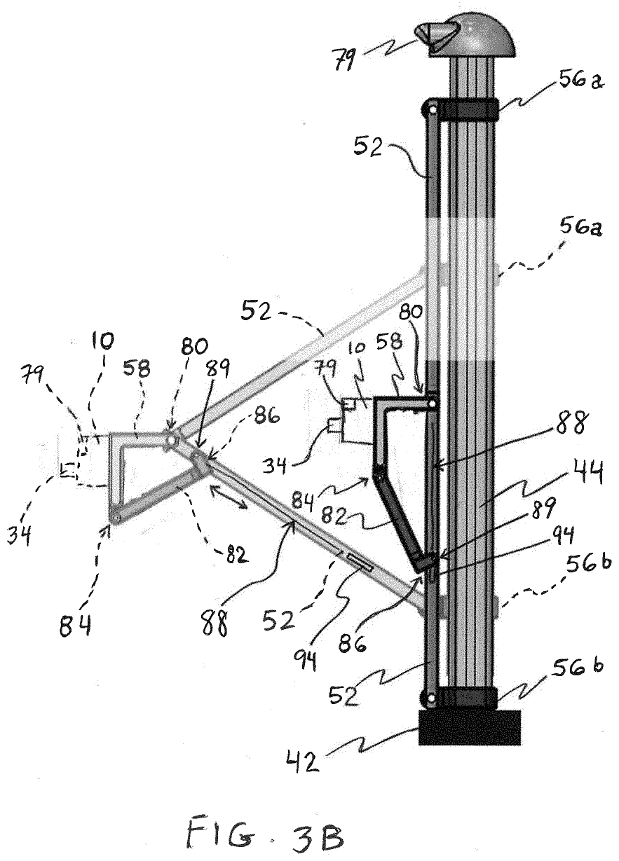

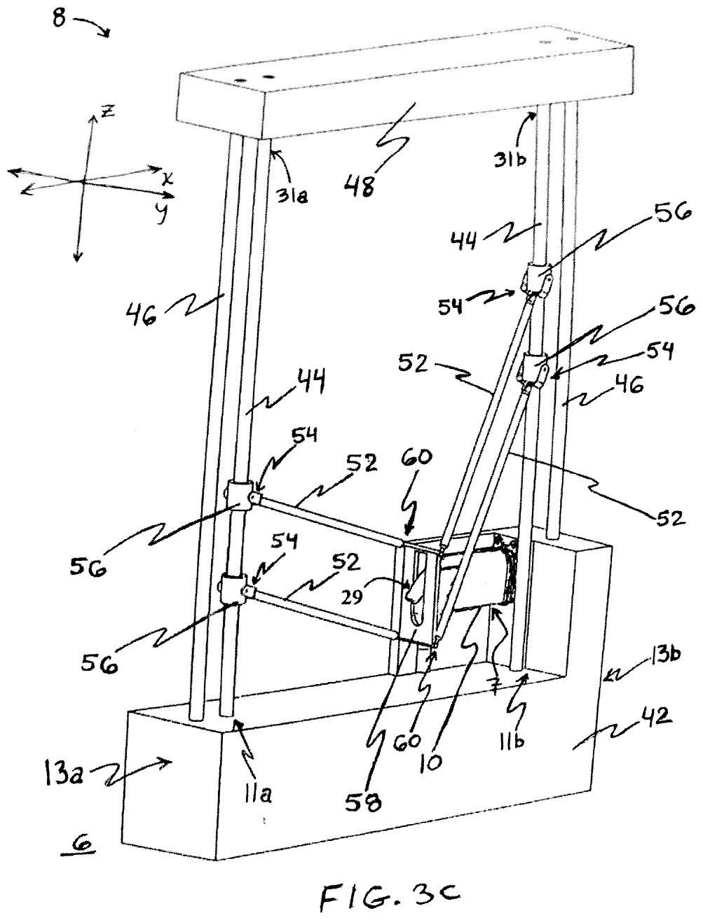

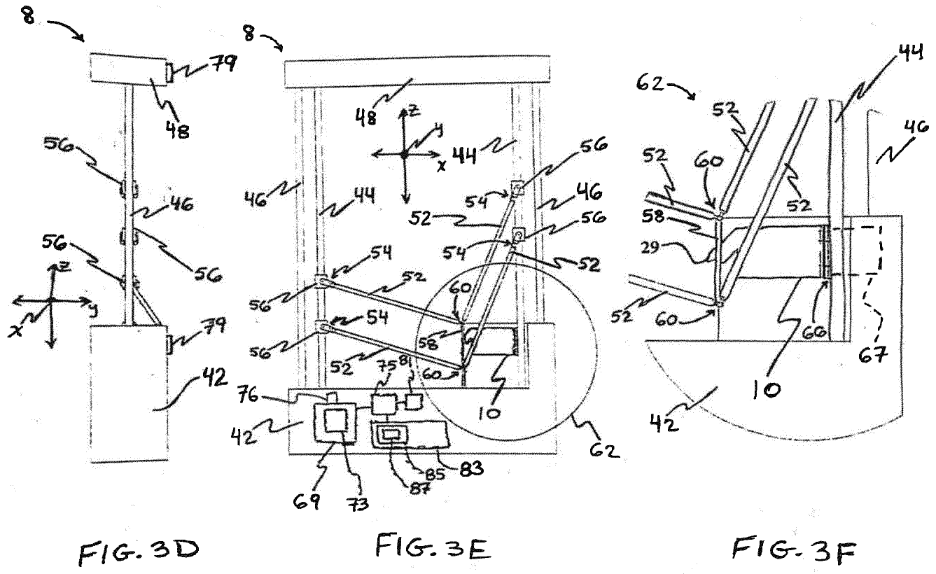

Embodiments of devices and systems for side-body charging of EVs 4 are shown in FIGS. 3A-5C and described below. FIGS. 3A-3F are schematic diagrams of aspects of the ACD 8 for side-body charging of EVs 4, including with the connector unit 10 in a stationary docked position 62, in accordance with embodiments of the disclosure. FIGS. 3A and 3B provide perspective views of the ACD 8 having one rail according to embodiments of the disclosure.

Referring to FIG. 3A, the ACD 8 includes a base 42 positioned on, in and/or coupled to the ground surface 6. Base 42 provides a stable structure supporting the remainder of the various ACD 8 component parts, as described herein. At least one vertical rail 44 is coupled to or otherwise mounted to base 42. Rail 44 extends vertically (e.g. upward in the z-direction) from a portion of the base 42. In the illustrated embodiment, the rail 44 defines a 90 degree angle with respect to a plane defined by a top of the base 42. In other embodiments, the rail 44 is positioned at an angle other than perpendicular to the base 42 plane.

In one embodiment, two slides 56 are positioned on the rail 44, as shown in FIG. 3A. The slides 56 are positioned on the rail 44 in a collar-like manner where the slides 56 have an inner space that is dimensioned to fit around a shape of the outer surface of the rail 44. For instance, where rail 44 is a cylindrical or ovoid rod, slide 56 has an annular collar or collar-like shape having an inner diameter that is equal to or just slightly greater than (e.g., by <1 mm) a diameter of the rail 44 such that slide 56 may be positioned at least partially around the rail 44. In other embodiments, rail 44 is a rod having a square or rectangular, instead of a circular or ovoid, cross-section, and slides 56 correspondingly have a square or rectangular collar or collar-like shape. In some embodiments, the slides 56 are slidingly engaged with the rail 44 to facilitate manual (e.g., by hand) or automated (e.g., robotic and/or motorized actuation) movement in a linear fashion up and down along the rail 44 (vertical movements, V).

The ACD 8 (which may at times be referred to in this disclosure more succinctly as “device 8”) includes connector unit 10. Connector unit 10 has a first end 7 and a second end 9 opposite the first end 7. Charger electrical connector 34 is positioned at the first end 7 of connector unit 10. An line or bundle of elongate conductor(s) (e.g., a cable, not shown) is coupled to and between charger electrical connector 34 and the power supply 5. Such a cable may interface with the power supply 5 via mechanical and electrical components (not shown) in or on the base 42.

An elongate support arm 52 is pivotably coupled to and between each slide 56 and a portion of the second end 9 of the connector unit 10. For example, one end of a first support arm 52 is pivotably coupled to a first portion 21 of the connector unit 10 second end 9 by way of a first ball joint 60, and an opposite end of the first support arm 52 is pivotably coupled to a portion of a first slide 56a by way of a first hinge 54. Likewise, one end of a second support arm 52 is pivotably coupled to a second portion 23 of the connector unit 10 second end 9 by way of a second ball joint 60, and an opposite end of the second support arm 52 is pivotably coupled to a portion of a second slide 56b by way of a second hinge 54. In one embodiment, the support arms 52 are rigid and of a one-piece construction, which may be solid or at least partially hollow. In some embodiments, support arms 52 have equivalent lengths and/or widths/diameters, while in other embodiments, at least one support arm 52 has a length and/or width/diameter that is different as compared to at least one other support arm 52. In some embodiments, portions of ball joints 60, hinges 54, support arms 52 and/or charger electrical connector 34 include compliance devices such as springs to allow for operational scenarios where portions of one or more of those ACD 8 components experience unintentional forces as in collisions or contact with objects in charging environment 3 other than the intended vehicle electrical connector 38 target.

In the illustrated embodiment of FIG. 3A, the connector unit 10 includes a connector holder 58 positioned proximal the second end 9 of the connector unit 10, where the connector holder 58 has the first 21 and second 23 portions to which the support arms 52 are attached via the ball joints 60. The first 21 and second portions 23 are positioned adjacent (e.g., either vertically or horizontally) to one another.

In one embodiment, slides 56 are slidingly engaged to move linearly along an axis 15 of rail 44. In another embodiment, in additional to being slidingly engaged with rail 44, slides 56 are rotatably engaged with rail 44 to rotate about the rail 44 axis 15. Additionally, or instead, the rail 44 may be rotatably coupled to the base 42. In another embodiment (not shown), rail 44 includes a notch or slot formed along at least a portion of its vertical length and slide 56 includes a correspondingly shaped and dimensioned slot or notch formed in its inner collar surface. In such embodiments, slides 56 are not rotatable about the rail 44 axis 15. Additionally, or instead, slides 56 are not freely slideable on rail 44. For instance, rail 44 may include along at least a portion of its length a plurality of circumferentially formed and axially spaced notches or slots. These structures may extend from the rail 44 surface in an asymmetric manner. In those embodiments, slides 56 are moveable up and down along the rail 44 only in response to an applied force having a vector component directed at an angle of less than 90 degrees with respect to the rail 44 surface. Similarly, in examples where slides 56 are not freely slideable, inner surfaces of the collar or collar-like slides 56 may have notch- or slot-like structures extending from the inner surfaces, including asymmetrically.

Although the ACD 8 described with reference to the various disclosed embodiments is referred to using the “automatic” or “automated” descriptor, various design features of ACD 8 are also advantageously applied to manual non-automated/robotic/motorized EV 4 charging operations. For instance, embodiments with rail(s) 44 and/or slide(s) 56 having notches and/or slots on their inner surfaces facilitate “zero gravity” suspension of connector unit 10 in a desired position for use in EV 4 charging operations and/or for storage of connector unit 10 during times of non-use. A user need not have a very high level of strength, coordination and/or dexterity to operate device 8 in such cases. With a manually applied force (as by a light shaking of one support arm 52 while holding the other support arm 52 stationary), a slide 56 in such embodiments may be released and then moved, by hand, along rail 44. A series of such manual steps permits the user to safely and effectively manipulate connector unit 10 to position 30 and insert 32 the charger electrical connector 34 into the vehicle electrical connector 38. Embodiments having such zero gravity suspension-enabling features thus enable safe and ergonomically sound techniques for moving connector unit 10 by hand which is advantageous in use cases that do not include automation- and/or robot/motor-assisted actuation of slides 56. Even where the cable is quite heavy (e.g., for high power applications such as commercial EVs like buses), a user may still safely and effectively connect and disconnect the connectors (34, 38) by hand.

ACD 8 includes one or more actuators 73 and a controller 75 in communication with the actuator(s) 73 and/or at least one actuation system 69. In the example shown in FIG. 3A, rail 44 is hollow and ACD 8 includes two chains (or cables or belts) 93. The chains (or cables or belts) 93 are suspended by one or more pulleys 92 (e.g., free wheeling) positioned at an upper portion of the rail 44. Each chain (or cable or belt) 93 includes a permanent magnet 91 coupled to it such that the magnet 91 moves cooperatively with the chain (or cable or belt) 93. In one embodiment, slides 56 include paired magnets 91 on, or proximal, their inner collar surfaces to facilitate their linear sliding movement being bound to, and paired with, movements of the magnets 91 chains (or cables or belts) 91. In another embodiment, the slides 56 are at least partially formed of a ferromagnetic material and do not include paired magnets 91 and the magnets 91 coupled to the chains (or cables or belts) 93 are alone sufficient to couple slide 56 movement to chain (or cable or belt) 93 movement. A first chain (or cable or belt) 93a is installed in rail 44 for the linear sliding movement of a first slide 56a and a second chain (or cable or belt) 93b is installed in rail 44 for the linear sliding movement of a second slide 56b.

Actuator(s) 73 are positioned in the base 42. Each actuator 72 is operably coupled to a respective pulley for driving the first 93a and second 93b chains (or cables or belts). The first 56a and second 56b slides are thus independently actuatable vertically up and down along rail 44 under command by the controller 75. Motor driver circuitry and associated components (not shown) are included in ACD 8 for this purpose. In some embodiments, controller 75 includes an externally accessible control panel (not shown) including, for example, 3-position toggle switches, for a user of ACD 8 to manipulate to selectively and alternately command the movement of slides 56. In the example shown in FIG. 3A, the range of allowable actuated and/or manually sliding for slides 56 is limited by the lengths of support arms 52, the length of rail 44, and a present fixed position of a slide 56 other than the slide 56 being moved.

In other embodiments, the actuation system 69 of the various disclosed ACD 8 examples include alternative or additional components and actuator 73 types. Generally, actuators 73 may include electric motors and/or electric linear actuators. Motors and/or linear actuators may be DC and/or AC driven and may be of the stepper-type design. In one embodiment (not shown), the pulley(s) 92 and the chains (or cables or belts) 93 are positioned radially outside of the rail 44, which then need not be a hollow rail 44. In this embodiment, the chains (or cables or belts) 93 are coupled to a portion of the outer surface of the collar or collar-like slide 56. In another embodiment (not shown), chains (or cables or belts) 93 are coupled to slide(s) 56 by way of an attachment or fastener that extends through an open rail 44 slot from the chain (or cable or belt) 93 positioned inside the hollow rail 44 to the inner surface of the collar or collar-like slide 56. In yet another embodiment (not shown), at least a portion of the actuation system 69 and/or actuator(s) 73 is positioned at, in, on, and/or proximal, an upper portion of rail 44.

In an embodiment (not shown), actuation system 69 includes a rack and pinion geared configuration. In this embodiment, rail 44 includes a rack of teeth positioned along at least a portion of the rail 44 length and extending radially outward from the outside surface of rail 44. The collar or collar-like slide 56 includes a corresponding slot and is positioned on the rail 44 to engage with the rack via the slot. The slide 56 includes a pinion gear operably coupled to an actuator 73 motor to move the slide up and down the rail 44 under control of controller 75.

In yet another embodiment (not shown), the rail 44 is or includes a threaded spindle and the inner surface of the collar or collar-like slide 56 is correspondingly threaded. In this embodiment, the slide 56 does not freely slide along rail 44. Rather, the threaded slide 56 is positioned on the spindle rail 44 by being threaded onto the spindle rail 44. For example, in this embodiment, a portion of slide 56 include a through-hole axially bored through a slide 56 wall at a radial distance from a center axis of the slide 56 (which corresponds to the axis 15 of rail 44 at such times when slide 56 is engaged with the rail 44). In the example, positioning the threaded slide 56 onto the threaded spindle rail 44 includes first threading the slide 56 onto the spindle rail 44 to a desired initial position, and then inserting a slide guide rod through the hole in the slide 56 and finally coupling the slide guide rod to the base 42 so that slide guide rod is parallel to rail 44. In operation, in this embodiment, actuator(s) 73 selectively rotate the spindle rail 44 about axis 15 in clockwise and counter-clockwise directions. With the threaded slide 56 prevented from cooperatively rotating with the spindle rail 44 by the slide guide rod, the slide 56 will be responsively actuated vertically up or down along rail 44 depending on the direction of rotation of rail 44 by its respective actuator 73.

In still another embodiment (not shown), actuation of slides 56 along rails 44 utilizes vibration-based motion components and techniques. In examples where the rail 44 is a spindle rail 44 or where rail 44 includes the circumferential slots or grooves, the meshing portions as between the rail 44 outer surface and the slide 56 inner surface have different pitch diameters. With, for instance, linear actuator(s) 73 positioned on or in the slide 56, the slide 56 can be rocked back and forth in an oscillatory fashion to move up or down the rail 44 in an inch worm manner.

In some embodiments, the rails 44 are hollow and have alternating permanent magnets inside the hollow space inside rails 44 (e.g., attached to the inside of rail 44 walls). In an example embodiment, the collar or collar-like slides 56 include one or more conductor coils axially positioned in or on the slide 56. In response to receiving a current, the coils have induced in them an alternating magnetic field which, depending on a direction of the current through the coil(s), causes the slide 56 to move up or down along rail 44. In the example, slides 56 and rails 44 may be supplied in a prefabricated form for use in assembling ACD 8 including, without limitation, in the form of electromagnetic actuation devices supplied by Linmot®. These electromagnetic-type actuators 73 provide contactless actuation. Such contactless actuation techniques may be more compliant (e.g., when no power is supplied to actuator(s) 73) than other techniques such as geared systems and techniques where slides 56 are directly coupled to chains (or cables or belts). Thus, for instance, in the event of a power failure or other operational problem with ACD 8, a user may manually manipulate the connector unit 10 out of the vehicle electrical connector 38 without experiencing burdensome counter forces on account of actuators 73.

In some embodiments (not shown), force-limiting features may be included in the ACD 8 actuation system 69 and/or actuator(s) 73 to provide enhanced safety measures during operation. For example, once the charger electrical connector 34 of the connector unit 10 makes first contact with the vehicle electrical connector 38, a vibratory force overlay can be applied to the insertion force so that the overall gross insertion force is lowered for effecting the mating engagement of connector 34 to connector 38.

Referring to FIG. 3B, in one embodiment, ends of the two support arms 52 opposite slides 56 are rotatably coupled to one another by way of an arm hinge 80. In the embodiment, mount 58 is or includes an L-shaped bracket. A first end of the L-shaped bracket mount 58 is hingedly coupled to the arm hinge 80. In the embodiment, ACD 8 includes a mount bar 82. A first end of mount bar 82 is hingedly coupled to a second end of the L-shaped bracket mount 58 at a bar-to-mount hinge 84. A second end of mount bar 82 is coupled to an arm slide 86. Arm slide 86 is positioned on one of the two support arms 52 (the lower arm 52 in the example shown in FIG. 3B). In the embodiment, at least one of the two support arms 52 is at least partially hollow rather than of fully solid construction. The support arm 52 to which arm slide 52 is mounted includes axial arm slots 88 formed in opposite sides of the hollow portion of arm 52.

In the embodiment, actuation system 69 includes a linear actuator 94 in communication with controller 75 and positioned in a portion of the interior of the at least partially hollow support arm 52. This linear actuator 94 is coupled to a coupling 89 that is rotatably coupled to arm slide 86. In the embodiment, at least a portion of arm slide 86 is formed as a U-shaped bracket. The coupling 89 extends from an inner surface of each leg of the U-shaped bracket arm slide 86 and through the slots 88. The working end (e.g., the portion of linear actuator 94 that is movable linearly along an axis of support arm 52) is coupled to a portion of coupling 89 inside the hollow portion of the at least partially hollow support arm 52. The portion of linear actuator 94 having the motor for moving the working end is positioned at a fixed location inside the hollow portion of the at least partially hollow support arm 52. In another embodiment (not shown) linear actuator 94 and its means for coupling to arm slide 86 are positioned outside of the support arm 52 instead of being positioned in the interior of an at least partially hollow support arm 52.

In operation, in the embodiment of FIG. 3B, the controller 75 selectively and/or alternately causes linear actuator 94 to move the coupling 89, and thus the arm slide 86, linearly back and forth along the axis of the support arm 52 to position connector unit 10 at a desired tilt angle (e.g., angle A′ as shown in FIG. 3A) with respect to rail 44. In the embodiment, the range of tilt angles for connector unit 10, and thus for an orientation of electrical connector 34, is limited by the length of the slots 88 and/or linear actuator 94's range of motion. In another embodiment, device 8 does not include the mount bar 82 as described above with reference to FIG. 3B. Rather, a portion of connector unit 10 (e.g., by way of mount 58) is hingedly coupled to the arm hinge 80 and a motor (e.g., a geared motor, not shown) is positioned either in or on that portion of connector unit 10 or mount 58, or in or on at least one of the support arms 52 proximal arm hinge 80. In this embodiment, the geared motor is in communication with controller 75, which causes the geared motor to rotate connector unit 10 and/or mount 58 about arm hinge 80 to thereby position connector unit 10 at the desired tilt angle. In this embodiment, the tilt angles for connector unit 10 (and thus also electrical connector 34) may have a greater range of allowable values (e.g., greater than 180 degrees but less than 360 degrees) as compared to the embodiment illustrated in FIG. 3B since the rotation is not limited by slot 88 lengths or range of motion of linear actuator 94.

In another embodiment (not shown in FIGS. 3A and 3B), ACD 8 includes two, rather than one, rail 44 coupled to spaced portions of the base 42. For example, the spaced portions of the base 42 are positioned on opposite sides of the base 42. In the embodiment, one slide 56 is positioned on each of the two rails 44, where each slide 56 is actuated vertically up and down along the respective rails 44 by actuation system 69 according to, for example and without limitation, any of the above-described actuation methods and components.

Materials of construction and other specifications of rails 44, slides 56, hinges 54, support arms 52, ball joints 60, connector holder 58, pulley(s) 92, chains (or cables or belts) 93, magnets 91, and any associated fasteners and/or welds (not shown) are preferably selected for an efficient balance of cost, durability, aesthetic appeal and corrosion resistance. In combination, such selections must meet the requirement that they be able to support the weight of at least the connector unit 10 and the attached power supply cable (not shown) for use with ACD 8, both during movement and operational states of dynamic equilibrium.

In one embodiment, not shown, a flexible shroud covers the support arms 52 to prevent environmental egress and mitigate safety hazards during operation of device 8, and to present an aesthetically pleasing appearance for device 8. In device 8 embodiments having two pairs of slides 56, four corners of a rectangular-shaped shroud may be mounted to each of the four slides 56. Additionally, a portion of the shroud may be mounted to base 42 to provide greater coverage. In these embodiments, the shroud may be formed of a flexible material having elastic properties so as to not impede movements of the mechanical parts of device 8 during either manual or automated operation. As with planar portions of the base 42 that are visible to users and passerbies whether or not device 8 is being operated, shroud may be exploited by owners/operators of device 8 for advertising and/or promotional purposes in facilities where device(s) 8 is/are located.

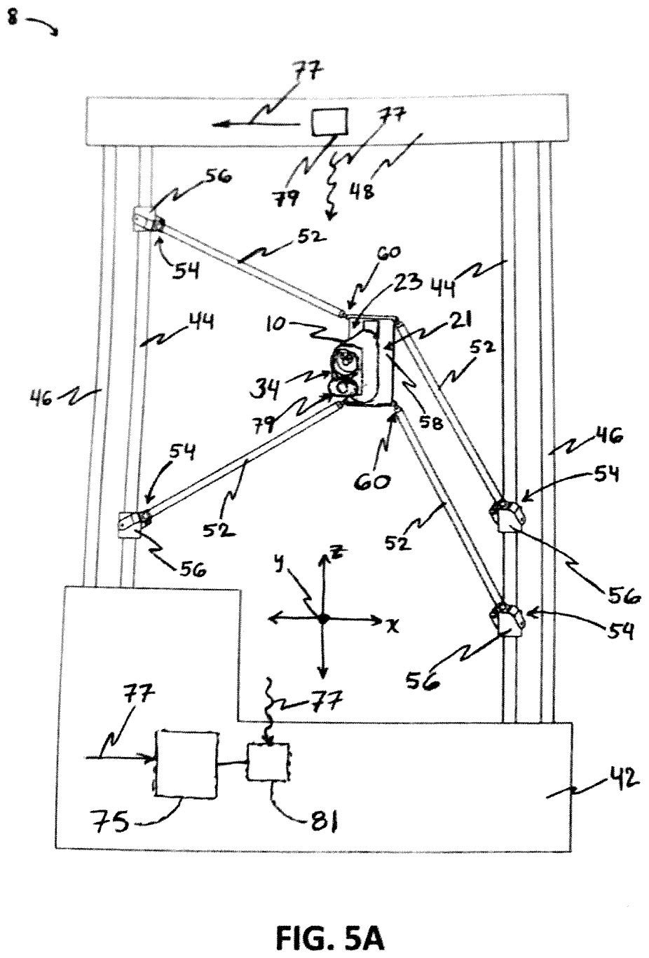

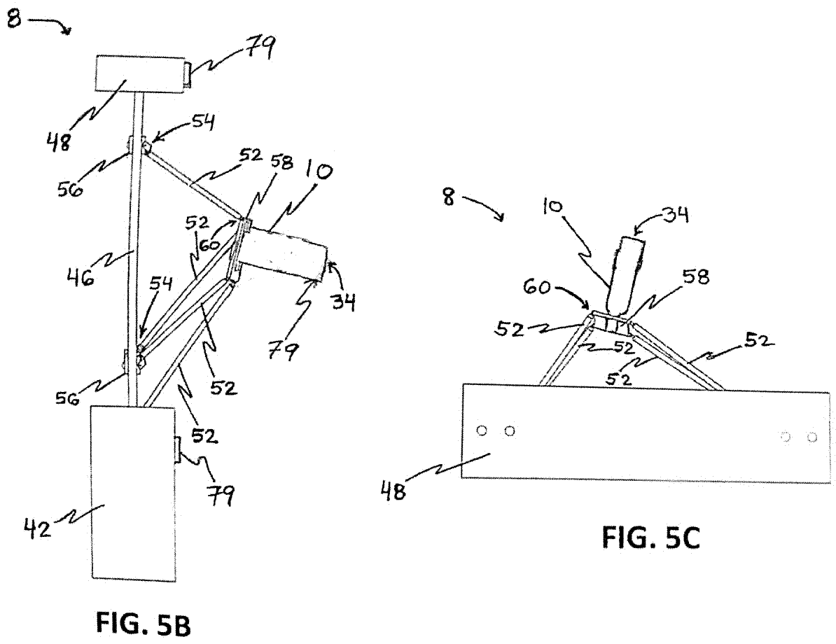

In operation, the connector unit 10 is positionable in any position axially along the length of rail 44 (vertical movements, V), and radially with respect to rail 44 axis 15 (radial movements, R) out to a distance (r) that is limited by support arm 52 lengths and the angles (A) they can achieve relative to axis 15. Such angles A are limited by the rail 44 length and the effective lengths of chains (or cables or belts) 93. In the illustrated example, slides 56 are selectively and independently actuatable to achieve a connector unit 10 position that is tilted at an angle (A′) with respect to rail 44 axis 15, which may be beneficial in cases where, for instance, an orientation of vehicle electrical connector 38 is tilted with respect to axis 15. The tilted position of connector unit 10 is shown in greater detail in FIGS. 5A-5C. Tilting connector unit 10 enables charger electrical connector 34 to be inserted into the mating vehicle electrical connector 38 with a variety of approach angles, as needed. The actuators 73 selectively and alternately rotate the rail 44, and so also all ACD 8 components attached to it, about axis 15 to move connector unit 10 through up to 360 degrees and to a desired final angular position. In some embodiments, the vertical sliding movements of either of the slides 56 and the rotation of the rail 44 is performed simultaneously under control of the controller 75. In operation, the connector unit 10 is thus also positionable in any angular position (angular movements, R′). In other embodiments, controller 75 orchestrates the vertical movements of slide(s) 56 in a separately timed sequence from (e.g., before or after) the rotational movement of rail 44. Controller 75 thus selectively and/or alternately causes the one or more actuator(s) 73 to independently actuate the slides 56 (linearly along rail 44) and/or the rail 44 (rotatably about axis 15).

As can be appreciated from the foregoing description, the slides 56 and the support arms 52 have passive degrees of freedom around the rail 44 axis 15 and also perpendicular to that axis 15. The connector unit 10 has at least two degrees of freedom and passive rotation with the at least two ball joints 60. By controlling the positions of the at least two hinged 54 slides 56 along rail(s) 44 three degrees of freedom mechanical translation in two degrees of freedom rotation is provided in combination with the passive rotation of the ball joints 60.

In one embodiment, ACD 8 includes one or more sensors 79 in communication with controller 75. ACD 8 includes at least one wired and/or wireless data communication receiver, transmitter and/or transceiver (collectively referred to as communication device 81) in communication with controller 75. Sensor(s) 79 are positioned in, on, or proximal, ACD 8 and/or elsewhere in charging environment 3 such as on or in ground surface 6. As such, sensor(s) 79 are positioned at least one of: in, and proximal, the charging environment 3 of the EV 4. Sensor(s) 79 receive signals from and/or generate data about charging environment 3 and EV 4 including, without limitation, whether or not unexpected or undesired objects or obstructions are present in environment 3, movements in environment 3, ambient conditions extant in environment 3 (e.g., temperature, wind speed, humidity, lighting), a presence of an EV 4 and/or an identity of the EV 4 and/or its driver in environment 3, among other information. Sensor(s) 79 may include multi-modal sensor(s) 79 (e.g., a camera that is capable of generating both still image photos and streaming or recorded video). Sensor(s) 79 also include communication devices (not shown). Multi-modal sensor(s) 79 receive signals 77 via wired or wireless communication lines from communication device 81, which contain commands from controller 75 as to which of two or more modes a particular sensor 79 is to operate in.

Sensor(s) 79 transmit to communication device 81 signals 77 encoding data that is representative of at least one of: a position of EV 4, and a position of the vehicle electrical connector 38, in the charging environment 3 broadly, or more specifically in the charging zone 9. The position of the EV 4 and/or its vehicle electrical connector 38 determined by processing and analysis performed by controller 75 is used by controller 75 for orchestrating targeted actuation of connector unit 10 and charger electrical connector 34 for EV 4 charging operations. In particular, in some embodiments, controller 75 analyzes the data encoded by signal(s) 77 to determine the position of the vehicle electrical connector 38 with respect to a position of the charger electrical connector 34 of device 8. These data are further used by the controller 75, either concurrently or consecutively, to selectively cause the actuator(s) 73 to actuate, according to the determined position of connector 38 with respect to connector 34, at least one of the slides 56 along axis 15 and/or to rotate the rail 44 about axis 15 to move the charger electrical connector 34 to a position in space that is sufficient to facilitate insertion of connector 34 into connector 38 according to the devices, systems and methods disclosed herein. In an example, controller 75 determines and implements a visual servoing-based actuation control scheme to actuate, according to the determined position connector 38 with respect to connector 34, the at least one slide 44 engaged with the one or more rail 44 to move charger electrical connector 34 for the insertion of connector 34 into vehicle electrical connector 38.

In some embodiments, controller 75 is or includes one or more processors having a central processing unit (CPU) and/or a graphics processing unit (GPU), which may be at least partially embodied in a general purpose computer and/or a mobile computing platform. Alternatively, or instead, controller 75 is or includes application specific integrated circuit(s) (ASIC(s)), programmable logic controller(s) (PLC(s)) and/or field programmable gate array(s) (FPGA(s)), among others. Computing (e.g., computational processing) and/or memory (e.g., data storage) resources need not be positioned at the location of the ACD 8. Such resources may be located, at least in part, remote from ACD 8 (e.g., in the cloud) and associated computing and/or data storage operations may be implemented by way of remote data communication using wired or wireless methods, including by way of Internet and/or cellular networks, and using, for example, Internet of Things (IoT) protocols and/or standards.

In embodiments where controller 75 is or includes CPU- and/or GPU-based processors, for instance, ACD 8 includes at least one memory device 83 in communication with controller 75. One or more of the disclosed operations performed, implemented, or at least facilitated by controller 75 may rely on reading and executing program instructions stored as software (or firmware) 87. In one embodiment, memory device(s) 83 is or includes non-transitory computer-readable media (NT-CRM) 85 and software (or firmware) 87 is stored in the NT-CRM 85. Software (or firmware) 87 architecture may be provided in a modular design to facilitate troubleshooting, maintenance, and providing updates for ACD 8, as used, for example, in the EV 4 charging methods described herein.

In one embodiment, sensor(s) 79 include an imaging device (e.g., camera) capable of generating still or video images and transmitting image data as signal(s) 77 to the memory device(s) 83 and/or directly to controller 75. In the examples shown in FIGS. 3A-5C, ACD 8 includes two camera-type sensor(s) 79: one atop rail 44 and another in or on the first end 7 of connector unit 10. The connector unit 10 camera sensor 79 is utilized for providing data encoding positional information for the vehicle electrical connector 38 to controller 75 by way of signal(s) 77. To facilitate operations directed to guiding movement(s) of charger electrical connector 34 to a position in space that is sufficient to permit its mating engagement with vehicle electrical connector 38, connector unit 10 may include a light (not shown) at its first end 7 to facilitate imaging and/or computer vision-related operations. The camera sensor 79 positioned atop, or at an upper portion of rail 44 provide higher angle views, and is utilized for providing data encoding positional information for the EV 4 itself to controller by way of signal(s) 77 as the EV 4 approaches, enters, and comes to rest in charging environment 3. In one embodiment, a resolution (e.g., as measured in megapixels) of the EV 4-localizing camera sensor 79 is lower than a resolution of the vehicle electrical connector 38 localizing camera sensor 79.

In the embodiment, sensor(s) 79 are motion detection sensor(s) or they include motion-detecting modes. Alternatively, separate motion sensor(s) 79 may be utilized and positioned in, on, and/or proximal ACD 8 or elsewhere in or near charging environment 3. In a use case, the camera sensor 79 set to a motion sensing mode during non-use periods of ACD 8 is positioned on or atop rail 44, and is used to wake up controller 75 (e.g., from a sleep or other low power mode) in response to signal(s) 77 indicating that EV 4 is approaching, or entering, charging environment 3. Optionally, this sensor 79 is used for controller 75 to identify the EV 4 and/or its driver to, for instance, cause an audible greeting to be transmitted, cause a particular song to be played and/or to cause function(s) of a smart home system 99 (e.g., a lighting scheme inside a garage to be illuminated and/or a notification to be transmitted to smartphone(s) of an EV 4 driver's family member(s)) to be implemented. Upon being woken up, controller 75 may begin actuation of slides 56 and/or rail 44 to start to move and/or orient connector unit 10 into and/or toward environment 3, respectively. In the embodiment, lower resolution images and/or video suffice for such controller 75 functions.

In the use case, upon controller 75 determining that, based on data from the rail 44-positioned camera sensor 79, EV 4 has come to rest in the charging zone 9, the connector unit 10 camera sensor 79 may be awoken from a sleep or other low power usage state and, optionally, the aforementioned connector unit 10 light may be illuminated. The controller 75 causes the actuation system 69 and/or actuator(s) 73 to move the slide(s) 56 and/or rail(s) 44 to thereby position the charger electrical connector 34 for insertion into, and mating engagement with, the vehicle electrical connector 38. Use of the connector unit 10 camera sensor 79 image data for automation of these motorized actuations in ACD 8 in operation may benefit from higher resolution images in the associated computer vision-based processing and actuator 73 control by controller 75. Although initial actuations and/or actuation sequences that are caused to be performed by controller 75 may be coarse during such times that charger electrical connector 34 is positioned at or beyond a predetermined distance (d) from vehicle electrical connector 38, finer actuations may be implemented by controller 75 during such times that connector 34 has closed in to connector 38 within distances less than d.

In another embodiment (not shown), ACD 8 includes only the camera sensor 79 having the motion-detection functionality positioned in or on the connector unit 10. In the embodiment, during times of non-use of ACD 8, connector unit 10 having motion detection-capable sensor 79 is stowed in a position on an upper portion of rail 44. In the embodiment, the connector unit 10 sensor 79 is oriented in view of changing environment 3 during such times when connector unit 10 is in the stowed position. This embodiment enables controller 75 to be woken up, and for the full range of imaging and computer vision-based processing and actuator 73 control by controller 75 to be performed as described above using a single sensor 79 having motion-detection and camera imaging modes.

In one embodiment, camera sensor(s) 75 are capable of imaging at wavelengths of light that are invisible to human eyes (e.g., ultraviolet (UV)), either instead of, or in addition to, visible light. At least one sticker and/or area painted, or printed, with UV-visible ink may be placed on, or proximal, vehicle electrical connector 38 to facilitate connector 38 localization and relative positioning of connector 34 with respect to connector 38 using computer vision-based control techniques. In an example, a set of 3 points defining a triangle are placed in this fashion to mark the position and orientation of the vehicle electrical connector 38 for use in computer vision-based processing and actuator 73 control by controller 75 implementing the visual servoing-based actuation control scheme. In one embodiment, the visual servoing includes proportional motion control and asymptotic convergence. Such motion control algorithms make use of a distance offset representing a fixed known distance between the camera sensor 79 on the connector unit 10 and the charger electrical connector 34. This offset may be applied for the visual servoing-directed computations. Additionally, or instead, such computer vision-based processing and actuation control techniques may make use of the actual representative image of at least a partial frontal view of the vehicle electrical connector 38 as viewed by connector unit 10 camera sensor 79 during operation of ACD 8.

In operation of device 8, as in performance of method 28, gross EV 4 localization utilizes high angle camera sensor 79 positioned in or on an upper portion of rail 44. Additionally, or instead, of the high angle camera imaging-based gross EV 4 localization, proper EV 4 placement and pairing may be employed (e.g., by markings on ground surface 6 and/or on at least a portion of ACD 8 that are visual to an EV 4 driver). Next, EV 4 inlet door localization for the vehicle electrical connector 38 is performed. Localization of the position of the EV 4 inlet door is initially a rough localization procedure facilitated by camera sensor(s) 79 positioned on connector unit 10 and/or on the upper portion of rail 44. This stage may include controller 75 of ACD 8 causing a signal to be sent to the vehicle unit 16 to automatically open the EV 4 inlet door. After finding the EV 4 inlet door position and causing the inlet door to be opened, localization of the vehicle electrical connector 38 is performed. This is a fine level localization, and includes determining the pose of the vehicle electrical connector 38 to a level of detail sufficient to plan motion of the ACD 8 components (e.g., slides 56) to attain a final position with charger electrical connector 34 inserted in a matingly engaged fashion into vehicle electrical connector 38. Either after, or concurrently with, localizing the vehicle electrical connector 38, the motion plan is executed using an actuator control scheme including visual servoing.

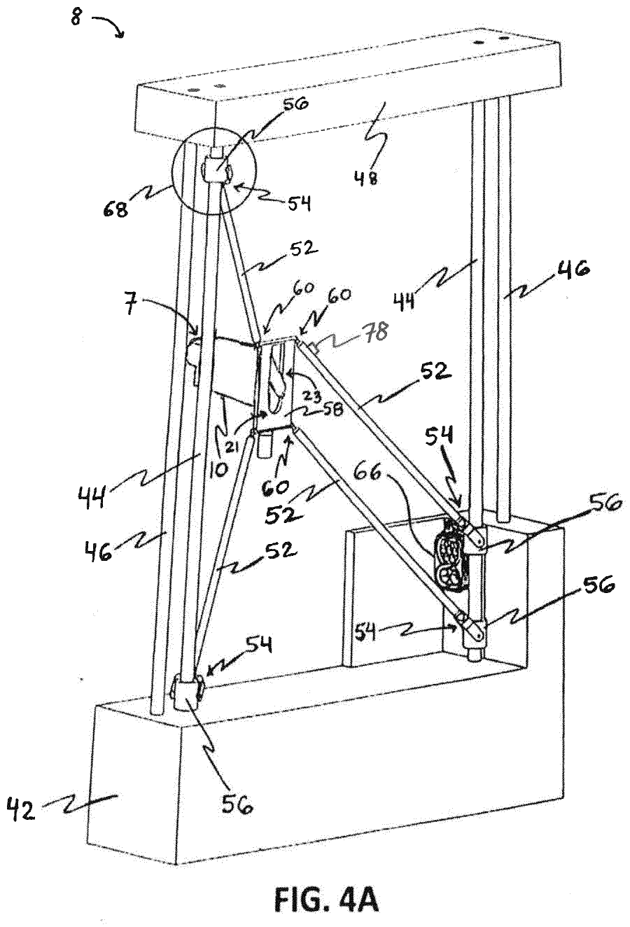

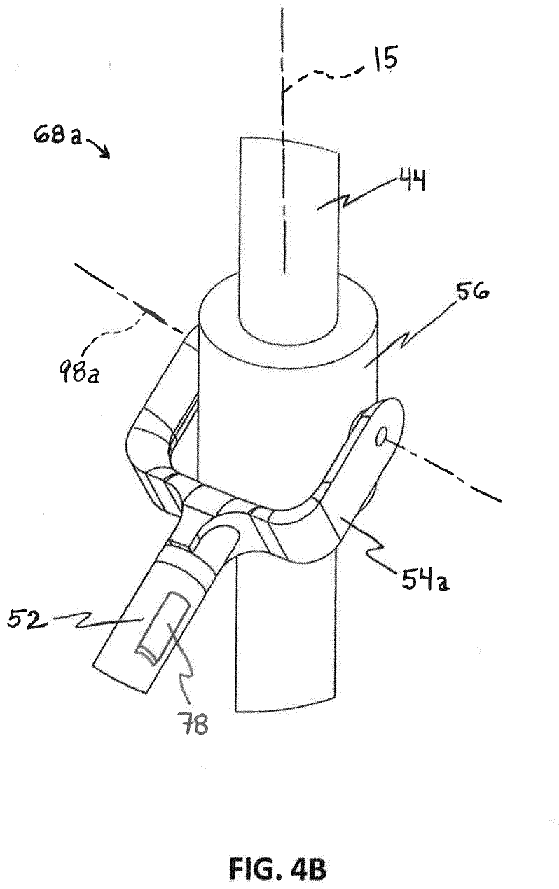

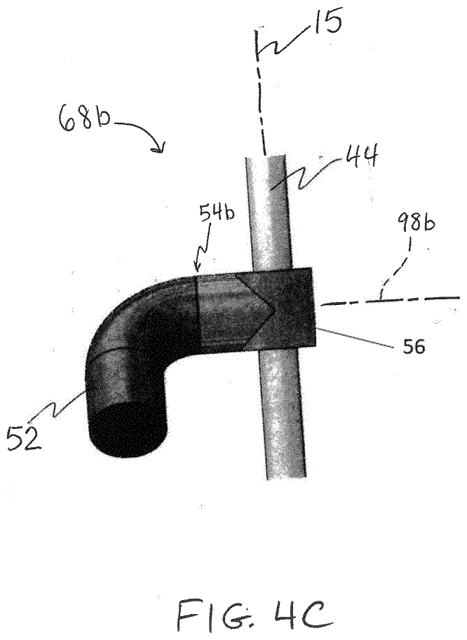

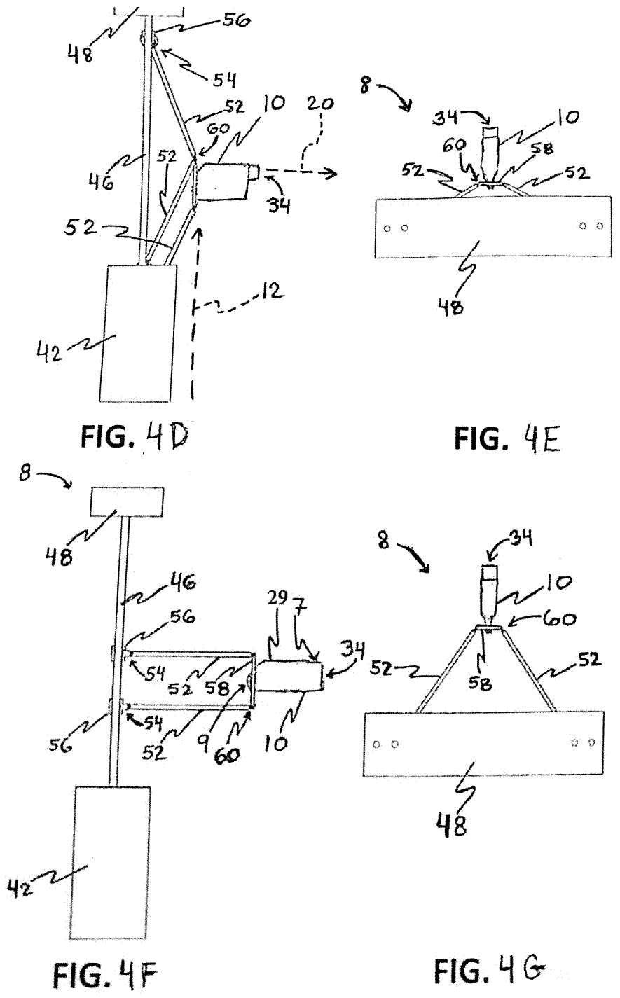

FIG. 3C provides a perspective views of the ACD 8 having two rails 44, including with the connector unit 10 in a docked position 62. FIGS. 3D and 3E are side views of the ACD 8 shown in FIG. 3C, and FIG. 3F is a detail side view of the docked position 62 of connector unit 10. FIGS. 4A-4G are schematic diagrams of aspects of the ACD 8 of FIGS. 3B-3E in actuated positions according to an embodiment of the disclosure. FIG. 4A provides a perspective view of the ACD 8 with the connector unit 10 in an actuated position. FIG. 4B is a detail perspective view of a slide 56 joint 68a having hinge 54a coupled to support arm 52 and positioned on and engaged with rail 44 of the ACD 8 that may be used with any of the device 8 embodiments of FIGS. 3A-4A and 4D-5C according to an embodiment of the disclosure. FIG. 4C. FIG. 4D is a detail perspective view of a slide 56 joint 68b having hinge 54a coupled to support arm 52 and positioned on and engaged with rail 44 of the ACD 8 that may be used with any of the device 8 embodiments of FIGS. 3A-4A and 4D-5C according to another embodiment of the disclosure. FIGS. 4D-4G are side and top plan views of actuated positions of components of the ACD 8. FIGS. 5A-5C are schematic diagrams of aspects of the ACD 8 with connector unit 10 in a tilted position according to an embodiment of the disclosure, including side (FIGS. 5A and 5B) and top plan (FIG. 5C) views thereof.

In the examples illustrated in FIGS. 3B-5C, ACD 8 includes base 42 positioned on or in a ground surface 6 and at least two vertical rails 44 coupled to spaced portions (e.g., 11a and 11b) of the base 42 and extending vertically upward from the base 42. At least one slide 56 is engaged with each rail 44 of the at least two rails 44, as described above with reference to FIG. 3A. In one embodiment, the slides 56 are slidingly engaged with the rails 44. In other embodiments, the slides 56 are positioned on, engaged with, and actuatable along, rails 44 according to any of the configurations shown and/or described above with reference to FIG. 3A. Connector unit 10 having a first 7 and second 9 ends includes charger electrical connector 34 at the first end 7. A plurality of elongate support arms 52 include at least one support arm 52 pivotably coupled to and between (e.g., by way of ball joint(s) 60 and hinge(s) 54) the at least one slide 56 engaged with a first rail 44 of the at least two rails 44 and a first portion (e.g., 21) of the second end 9 of the connector unit 10. At least one additional support arm 52 pivotably coupled to and between (e.g., by way of ball joint(s) 60 and hinge(s) 54) the at least one slide 56 engaged with a second rail 44 of the at least two rails 44 and a second portion (e.g., 23) of the second end 9 of the connector unit 10. In the example shown in FIGS. 3C-5C, the spaced portions (11a, 11b) of the base 42 to which the at least two rails 44 are coupled are positioned at opposite lateral sides of the base 42.

In the illustrated embodiment of FIGS. 3C-5C, ACD 8 includes a top piece 48 coupled to ends (e.g., top ends 31a and 31b) of the at least two vertical rails 44 opposite the base 42. The ACD 8 may include at least one support post 46 coupled to and between the base 42 and the top piece 48. In the illustrated embodiment of FIGS. 3C-5C, the at least one support post 46 includes at least two support posts 46 coupled to the spaced portions (11a, 11b) of the base 42. The ACD 8 embodiment of FIGS. 3C-5C includes the controller 75, memory 83 communication device 81, sensor(s) 79, actuation system 69 and actuator(s) 73 as shown and/or described above with reference to FIG. 3A. Controller 75, memory 83, communication device 81, sensor(s) 79, actuation system 69 and actuator(s) 73 are used for the same functions and beneficial ends, and with all the disclosed variations, as described above with reference to FIG. 3A.

In one embodiment, ACD 8 includes a docking station 66 positioned in or on the base 42 for receiving the first end 7 of the connector unit 10 and maintaining the first end 7 of the connector unit 10 in a stationary position 62. In another embodiment (not shown), docking station 66 is positioned in or on top piece 48 or in or on an upper portion of rail 44 and/or support post 46. In an example, the docking station 66 includes a means 67 for cleaning (e.g., a controllable valve (not shown) in flow communication with a supply of compressed air and/or fluid under pressure) the charger electrical connector 34 of the connector unit 10 in the stationary position 62. In the example, the cleaning means 67 is in communication with the controller 75 and the controller 75 causes the valve to selectively and alternately open and close to expose the charger electrical connector 34 to the compressed air and/or pressurized fluid for a predetermined duration of time when first end 7 connector unit 10 is docked in the docking station 66 in the stationary position 62.

Referring to FIG. 4B, in joint 68a, hinge 54a is or includes a U-shaped bracket hingedly coupled to slide 56. The two pivot points of hinge 54a on inner surfaces of each of the two legs of the U-shaped bracket lie on a pivot axis 98a and are coupled to opposite sides of slide 56. Support arm 52 is coupled to a base of the U-shaped bracket and extends away from hinge 54a and toward connector unit 10, as shown in FIGS. 3A and 3B. Joint 68a with hinge 54a may be used with any of the device 8 embodiments shown and described above with reference to FIGS. 3A-4A and 4D-5C.

In an alternative embodiment shown in FIG. 4C, joint 68b provides an equivalent function as joint 68a in the disclosed device 8, but with added safety precautions as compared to joint 68a. In joint 68b, hinge 54b is rotatably coupled to support arm 52 in a single planar region rather than via two pivot points as in hinge 54a. Thus, in joint 68b, hinge 54b has a single pivot axis 98b, where an end of support arm 52 and an end of hinge 54b define respective planes that are perpendicular to axis 98b and with at most a nominal gap between the planes. By arranging the degrees of freedom in joint 68b in the manner shown in FIG. 4C, the support arm 52 and hinge 54b of slide 56 come together without any gaps, thereby eliminating pinch points existing where gaps are opened and/or closed during operation of device 8. Separating the rotation axis and placing the rotation axis parallel to mechanical axes eliminates the pinch points. Foam pads on the moving knuckles can alleviate any remaining mechanical risks during operation. Joint 68b with hinge 54b may be used with any of the device 8 embodiments shown and described above with reference to FIGS. 3A-4A and 4D-5C.

In some embodiments, device 8 includes one or more safety release mechanisms to enable a user to manually move the connector unit 10 and/or other components of device (e.g., support arm(s) 52, rail(s) 44, slide(s) 56) in the event of a facility power outage that may lock electric actuators 73, or which causes the actuators 73 to be unable to be compliantly moved by hand, or another abnormal operational condition for device 8 that otherwise makes it difficult for components directly or indirectly operably coupled to actuator(s) 73 to be moved or positioned/repositioned manually. In such operational use cases, a device 8 user may desire or require that the charger electrical connector 34 of connector unit 10 be manually disengaged with the vehicle electrical connector 38. For instance, in order to drive the EV 4 away from device 8 and out of a parking garage, the connectors (34, 38) should be decoupled and disengaged from one another before attempting to move the EV 4. Thus, the safety release mechanism enables at least a portion of the actuation system 69 and its operation to be selectively and alternately enabled and disabled for use in device 8 according to the disclosed embodiments.

In one example, as shown in FIGS. 3A and 3E, the safety release mechanism(s) is/are embodied in at least one first release mechanism 76. First safety release mechanism 76 is operably coupled to at least a portion of actuator 73 and/or at least a portion of a respective device 8 component (e.g., chain (or cable or belt) 93 and/or rail 44) that is directly actuatable by actuator 73. First release mechanism 76 is positioned in device 8 to be accessible to device 8 users to operate manually. First safety release mechanism 76 assumes at least two positions in device 8 during operation. A first position of mechanism 76 is a disengaged position that enables actuation of a device 8 component by the respective actuator 73 by maintaining the respective device 8 component operably coupled to actuator 73. A second position of mechanism 76 is an engaged position that disables actuation of the device 8 component by the respective actuator 73 by decoupling the actuator 73 from the respective component, thereby enabling the respective component to be compliantly moved by hand. In this manner, removing the physical connection between the actuator 73 and the device 8 component that is respectively actuatable by the actuator 73 results in the movements of the respective device 8 component no longer being constrained by the electro-mechanical and kinematic constraints of actuator 73.

In another example, as shown in FIGS. 3A, 4A and 4B, the safety release mechanism is embodied in a second release mechanism 78. Second safety release mechanism 78 is operably coupled to at least a portion of a device 8 component that is indirectly caused to be moved by actuation of a connected device 8 component by actuator(s) 73 (e.g., hinge 54, joint 60, magnet 91, pulley 92). Second release mechanism 78 is positioned in device 8 to be accessible to device 8 users to operate manually. Second safety release mechanism 78 assumes at least two positions in device 8 during operation. A first position of mechanism 78 is a disengaged position that enables the device 8 component to be indirectly moved by the actuation of a connected device 8 component by actuator(s) 73 by maintaining the respective device 8 component operably coupled to the connected device 8 component to enable that indirectly actuated movement. A second position of mechanism 78 is an engaged position that disables the indirect actuation of the device 8 component by the actuation of the connected device 8 component by the respective actuator 73 by decoupling the connected device 8 components, thereby enabling at least one of the connected components to be compliantly moved by hand. In this manner, removing the physical connection between the linked device 8 components results in the movements of one or more of them no longer being constrained by the mechanical and kinematic constraints of the parallel mechanism of the disclosed devices 8.

As with the ACD 8 embodiment shown and described above with reference to FIG. 3A, the slides 56 and the support arms 52 of the ACD 8 (e.g., as shown with the movement sequences of connector unit 10 in FIGS. 3B-5C) have passive degrees of freedom around the rail 44 axes 15 and also perpendicular to that axis 15. The connector unit 10 likewise has at least two degrees of freedom and passive rotation with the at least two ball joints 60. By controlling the positions of the at least two hinged 54 slides 56 along rail(s) 44 three degrees of freedom mechanical translation in two degrees of freedom rotation is provided in combination with the passive rotation of the ball joints 60.

After EV 4 is charged using the above-described devices, systems and methods, or upon EV 4 needing to depart EV charging environment 3 for any reason decoupling of the charger electrical connector 34 from the vehicle electrical connector 38 and manual or automated/actuated movement of the connector unit 10 from its final position back to its initial position may be accomplished by implementing the various disclosed kinematic and computer processes in a reverse sequence.

Various embodiments disclosed herein are to be taken in the illustrative and explanatory sense, and should in no way be construed as limiting of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A device for charging of an electric vehicle (EV) including a vehicle electrical connector, the device comprising:
a base;
a vertical rail coupled to the base and extending vertically from the base;
a pair of slides engaged with the rail;
a connector unit having a first end and a second end;
a pair of elongate support arms, each support arm of the pair of support arms pivotably coupled to and between: one slide of the pair of slides, and one of two portions of the second end of the connector unit.

2. The device of claim 1, wherein the rail is rotatably coupled to the base.

3. The device of claim 1, wherein the first portion of the second end of connector unit is positioned adjacent to the second portion of the second end of connector unit.

4. The device of claim 1, wherein the connector unit further includes a connector holder positioned proximal the second end of the connector unit, the connector holder having the first and second portions of the second end.

5. The device of claim 1, wherein each support arm of the pair of support arms is pivotably coupled to a ball joint coupled to the first portion or the second portion of the second end.

6. The device of claim 1, further comprising an actuation system configured to independently actuate each slide of the pair of slides.

7. The device of claim 6, wherein the actuation system is further configured to independently linearly actuate the each slide vertically along the rail to selectively position the connector unit at least one of: vertically, and radially, with respect to an axis of the rail.

8. The device of claim 6, wherein the actuation system is further configured to rotatably actuate the rail about an axis of the rail to selectively position the connector unit angularly with respect to the axis of the rail.

9. The device of claim 6, wherein the actuation system includes:
one or more actuators; and
a controller in communication with the one or more actuators,
wherein the controller is configured to selectively cause the one or more actuators to independently actuate at least one of the pair of slides.

10. The device of claim 9, wherein the controller is further configured to:
receive at least one signal from one or more sensors positioned at least one of: in, and proximal, a charging environment of the EV, wherein the at least one signal encodes data that is representative of at least one of: a position of the EV, and a position of the vehicle electrical connector, in the charging environment;
analyze the data encoded by the at least one signal to determine the position of the vehicle electrical connector with respect to a position of the charger electrical connector; and
selectively cause the one or more actuators to actuate the at least one of the pair of slides according to the determined position to move the charger electrical connector for insertion of the charger electrical connector into the vehicle electrical connector.

11. The device of claim 10, further comprising the one or more sensors.

12. A device for charging of an electric vehicle (EV) including a vehicle electrical connector, the device comprising:
a base;
at least two vertical rails coupled to spaced portions of the base and extending vertically from the base;
at least one slide engaged with each rail of the at least two rails;
a connector unit having a first end and a second end; and
a plurality of elongate support arms including at least one support arm pivotably coupled to and between the at least one slide engaged with a first rail of the at least two rails and a first portion of the second end of the connector unit, and at least one additional support arm pivotably coupled to and between the at least one slide engaged with a second rail of the at least two rails and a second portion of the second end of the connector unit.

13. The device of claim 12, further comprising an actuation system configured to independently actuate the at least one slide engaged with the each rail.

14. The device of claim 13, wherein the actuation system is further configured to independently linearly actuate the at least one slide engaged with the each rail vertically along the each rail to selectively position the connector unit at least one of: vertically, and radially, with respect to an axis of the rail.

15. The device of claim 13, further comprising a safety release mechanism including a means for selectively and alternately enabling and disabling operation of at least a portion of the actuation system to independently linearly actuate the at least one slide.

16. The device of claim 13, wherein the actuation system includes:
one or more actuators; and
a controller in communication with the one or more actuators,
wherein the controller is configured to selectively cause the one or more actuators to independently actuate at least one of the pair of slides.

17. The device of claim 16, wherein the controller is further configured to:
receive at least one signal from one or more sensors positioned at least one of: in, and proximal, a charging environment of the EV, wherein the at least one signal encodes data that is representative of at least one of: a position of the EV, and a position of the vehicle electrical connector, in the charging environment;
analyze the data encoded by the at least one signal to determine the position of the vehicle electrical connector with respect to a position of the charger electrical connector; and
selectively cause the one or more actuators to actuate, according to the determined position, the at least one slide engaged with the each rail to move the charger electrical connector for insertion of the charger electrical connector into the vehicle electrical connector.

18. The device of claim 17, wherein the controller is further configured to determine and implement a visual servoing-based actuation control scheme to actuate, according to the determined position, the at least one slide engaged with the each rail to move the charger electrical connector for insertion of the charger electrical connector into the vehicle electrical connector.

19. The device of claim 17, further comprising the one or more sensors.

20. The device of claim 12, further comprising a docking station positioned in or on the base for receiving the first end of the connector unit and maintaining the first end of the connector unit in a stationary position.

21. The device of claim 20, wherein the docking station includes a means for cleaning the charger electrical connector of the connector unit in the stationary position.

22. A method for charging of an electric vehicle (EV), comprising:
positioning a charger electrical connector of a charging device with reference to a mating vehicle electrical connector positioned proximal a side-body panel of the EV, wherein:
the positioning includes actuating the charger electrical connector from an initial position to a final position with the charger electrical connector matingly engaged with the vehicle electrical connector; and
the actuating including moving at least two slides coupled to the charger electrical connector by way of at least two support arms vertically along at least one rail of the charging device to selectively position the charger electrical connector at least one of: vertically, and radially, with respect to an axis of the at least one rail;
inserting the charger electrical connector of the charging device into the mating vehicle electrical connector; and
initiating an EV charging process by selectively enabling a flow of electric current from an electric power supply through the matingly engaged charger and vehicle electrical connectors.
